(19) United States
(12) Patent Application Publication
(10) Pub. No.: US 2020/0116278 A1
(43) Pub. Date: Apr. 16, 2020

(54) Pipeline Installation System

(71) Applicant: TB Services, LLC, Houma, LA (US)

(72) Inventor: Robert Thompson, JR., Houma, LA (US)

(73) Assignee: TB Services, LLC, Houma, LA (US)

(21) Appl. No.: 16/654,515

(22) Filed: Oct. 16, 2019

Related U.S. Application Data
(60) Provisional application No. 62/746,299, filed on Oct. 16, 2018.

(51) Int. Cl. F16L 1/032; F16L 3/26

(52) U.S. Cl. CPC F16L 1/032; F16L 3/26

(57) ABSTRACT

The present invention relates to an improved system and method for the assembly and installation of pipeline. In accordance with aspects of the invention, the pipeline is assembled at one or more assembly sites located at a particular location of a pipeline route. The pipeline is pulled out of the assembly site and along a trench using a transport unit, such as a winch. The trench may contain a plurality of conveyance units, such as rollers, over which the pipeline is conveyed. The pipeline may continue to be pulled through the trench as portions of the pipeline are assembled at the assembly site, and the pipeline may be pulled until the pipeline has reached a desired location within the trench.

### CROSS-REFERENCE TO RELATED APPLICATION

The present application claims the benefit of the filing date of U.S. Provisional Patent Application No. 62/746,299 filed Oct. 16, 2018, the disclosure of which is hereby incorporated herein by reference.

### BACKGROUND OF THE INVENTION

Pipelines allow for the transport of various resources and materials, such as oil, natural gas, and water, over very long distances. As such, pipelines constitute an important part of national and global infrastructure. However, the construction and installation of pipelines is expensive, time consuming, and labor intensive. For example, in a conventional pipeline installation process, a trench is formed along what is expected to be the entire length of the final pipeline and pipe segments are laid out next to the trench. This is referred to as the “stringing phase” of installation. Workers then align the pipe segments that have been laid next to the trench and connect the segments by welding them together. In addition to welding, other groups of workers perform various tests on each welded pipe segment and typically apply a protective coating onto the weld joints. Once a number of pipe segments have been connected, the resulting portion of pipeline can be lifted up and lowered into the adjacent trench, in what is referred to as the “lower-in phase” of installation.

Accordingly, the conventional process for installing onshore pipeline requires various groups of workers to traverse the entire length of the pipeline, so as to perform the various steps of pipeline construction and installation. This approach required each group of workers to set up, break down and move their equipment numerous times, so that the steps of welding, inspecting, coating, and lowering can be performed for each pipeline segment.

### BRIEF SUMMARY OF THE INVENTION

The present pipeline system and methods of installation allow for long sections of pipeline to be assembled and installed along an onshore pipeline route without requiring that the various pipeline assembly operations occur along the entire pipeline route. In accordance with the disclosed system, a pipeline may be assembled in stages at a particular location within the pipeline route. A winch is preferably used to pull the assembled pipeline through the various stages of assembly. Moreover, the winch may be located along the pipeline route at a remote location relative to the assemble location, so that as the pipeline can be pulled through the assembly stages along the pipeline route until the entire length of pipeline between the winch and assembly location has been assembled and pulled into the location where the pipeline will be installed. In order to enable the winch to pull the assembled pipeline along the pipeline route, a plurality of rollers may be placed along the route, so as to reduce the friction associated with pulling the pipeline. In addition, the pipeline route is preferably defined by a trench, with the rollers being located within the trench.

In accordance with aspects of the invention, the onshore pipeline installation may comprise an assembly site having a plurality of assembly stations that are each configured to perform one or more pipeline assembly operations at a particular assembly location; a plurality of conveyance units located along a pipeline route, wherein at least a portion of the conveyance units are located within an excavated portion of the pipeline route; and a transport unit at a second location, wherein the transport unit is configured to move the pipeline within the pipeline route a predetermined distance after completion of the pipeline assembly operations performed at the plurality of assembly stations.

In accordance with aspects of the invention, one or more of the assembly operations that include welding, inspection, and coating of the pipeline are performed at corresponding assembly stations. In addition, the transport unit may comprise a winch and one or more cables that are extended from the winch to a portion of the pipeline, so as to move the pipeline by pulling the pipeline toward the winch.

In accordance with an aspect of the invention, each conveyance unit may comprise one or more rollers that are configured to reduce friction as the pipeline is moved. In addition, the excavated portion of the pipeline route may comprise a trench that substantially extends from the assembly site to the transport unit.

### BRIEF DESCRIPTION OF THE DRAWINGS

FIG. 1 is a diagram of a pipeline installation system in accordance with aspects of the invention.

FIG. 2 is first view of pipeline roller units, as used in accordance with aspects of the invention.

FIG. 3 is another view of pipeline roller units.

FIG. 4 is a view of pipeline roller units, as they are removed from a trench in accordance with aspects of the invention.

FIGS. 5 through 12 are diagrams of a pipeline installation system at varying periods of time.

FIG. 13 is a view of a roller unit that may be used in accordance with aspects of the invention.

FIGS. 14a-14c provides three views of a roller cartridge that may be used in accordance with aspects of the invention.

FIGS. 15a-18b provide views of roller units that may be used in accordance with aspects of the invention.

FIGS. 19a-19f provide a sequence of views of a roller unit as it is removed from a trench.

FIGS. 20a-20d provide views of hydraulic-driven rollers that may be used in accordance with aspects of the invention.

FIG. 21a-23b provide views of adjustable pipe support stands that may be used in accordance with aspects of the invention.

### DETAILED DESCRIPTION

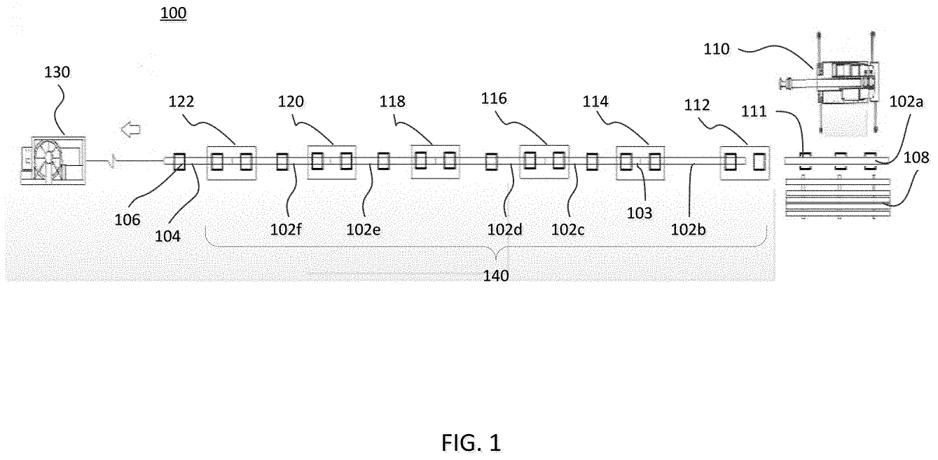

FIG. 1 is an exemplary diagram of a pipeline installation system 100 according to one embodiment. System 100 includes a winch 130 at a first location, an assembly site 140 at a second location, and a plurality of roller units 106 positioned at various locations between the first location and the second location. The distance between winch 130 and assembly site 140 can depend on the type of pipeline being installed, as well as the terrain in which the pipeline is being installed. For some pipelines, the distance between winch 130 and assembly site 140 may be 5,000 to 10,000 feet or more.

Assembly site 140 may include a number of assembly stations 112-122 that are configured to assemble a pipeline 104 from a plurality of pipe segments 102, while winch 130 is configured to pull the assembled pipeline 104 through assembly site 140 and toward the pipeline's final installation position. For example, one or more cables may be extended from winch 130 and attached to pipeline 104. Winch 130 may then be activated to wind the one or more cables, so as to pull pipeline 104 toward winch 130.

Assembly stations 112-122 may be positioned relative to one another so that each assembly station is able to work on particular pipe segments 102 simultaneously. For example, a cherry picker 110 is configured to load pipe segment 102a from a storage rack 108 so that pipe segment 102a can be brought to station 112 and loaded onto prep stands 111. At station 112, a bead and hot pass is performed so that pipe segment 102a can be connected to pipe segment 102b.

While the bead and hot pass welding steps are being performed at station 112, the other assembly stations 114-122 may simultaneously perform various steps of the pipeline assembly on other pipe segments 102. For example, welding fill may be performed at station 114 for the joint of pipe segments 102b and 102c, while station 116 may perform additional welding fills on the joint of pipe segments 102c and 102d. During this time, station 118 can complete the welding procedure for the joint between pipe segments 102d and 102e, such as by applying weld caps to the welded joint. In addition, station 120 may perform various inspection steps, so as to confirm that a proper weld has been made on the joint of pipe segments 102e and 102f and to confirm that there are no other fractures or defects in the pipe segments. During this time, station 122 may complete the assembly process, such as by cleaning and coating portions of pipeline 104, as it is brought through station 122. Pipeline 104 is preferably checked with a Holiday Detector after leaving station 122.

Once each of the assembly stations 112-122 have performed their designated assembly operations on a corresponding segment of pipeline 104, winch 130 may be activated to pull pipeline 104 by a predetermined distance, so as to allow each pipe segment 102 in pipeline 104 to enter the next assembly station within assembly site 140. For example, after station 114 has performed the welding fill steps for joint 103 of pipe segments 102b and 102c, winch 130 may pull pipeline 104 a predetermined distance so that joint 103 of pipe segments 102b and 102c traverses from station 114 to station 116. Similarly, every other pipe segment 102 within the assembly site 140 will move “downstream” to the next station in assembly site 140 until the segment has completed the final station 122, at which point the segment will be pulled out of the assembly site 140, and into a pipeline trench, as a completed portion of pipeline 104.

In accordance with the disclosed system and methods, each station 112-122 may be configured to perform a set of assembly tasks that take approximately the same amount of time to complete. For example, by dividing the welding process over the four stations 112, 114, 116, and 118, each welding step may be completed in around ten to twelve minutes or less. Similarly, the inspection and coating process performed at stations 120 and 122, respectively, may take less than ten to twelve minutes. In accordance with aspects of the disclosed system and methods, each assembly station 112-122 may be equipped with a mechanism for indicating that the station has completed its task for the current pipe segment. For example, each assembly station may have a button located at the station, which when pressed by a worker, provides signal resulting in a visual or audible indication that the station has completed its task and the pipe segment 102 may be moved on to the next station. The signals provided by each assembly station may be referred to as a completion signal. In addition, one or more assembly stations may be automated, in which case the automated station may be programmed or otherwise configured to provide a signal once a task has been completed. Once all assembly stations have activated their completion signal, winch 130 may be activated to begin pulling pipeline 104 a predetermined distance. Once winch 130 has pulled pipeline 104 the predetermined distance, winch 130 may hold pipeline 104 at its current location until all of the assembly stations provide another completion signal.

The completion signals may be transmitted and collected in any number of ways. For example, the completion signal may include the activation of a light that can be observed by one or more workers at the assembly site 140. Once the one or more workers have observed the activation of a light at each assembly station, a message or signal may be sent to winch 130 indicating that pipeline 104 can again be moved the predetermined distance. Alternatively, the completion signals may be transmitted electronically, and computer or other processing unit, either at winch 130 or at another location, may determine, based on the transmitted completion signals, that all of the assembly stations have indicated completion of their task. Once this determination has been made, winch 130 may be activated to begin pulling pipeline 104 a predetermined distance.

In addition, a determination may be made that one or more assembly stations has failed to provide a completion signal in a predetermined period of time. In such an instance, a message or other signal may be sent requesting that assistance be provided to the one or more assembly stations. For example, if an assembly station fails to provide a completion signal after ten minutes, a computer or other processing unit may send the assembly station a message that seeks to determine whether a problem has occurred. If a problem is identified, the computer may send a message to one or more locations indicating that assistance is needed at a particular assembly station.

The time it takes winch 130 to pull pipeline 104 the predetermined distance will vary depending on the type of winch that is used, as well as attributes of the pipeline and terrain. However, for a 12″ schedule 40 pipeline, the process to move a segment from a first assembly station to a second assembly station will often take no more than two minutes. When this time is added to the approximately ten minutes that each pipe segment 102 spends at each assembly station, system 100 may be configured to complete the assembly process for five or more pipe segment joints every hour. In turn, close to 5,000 feet of pipeline may be assembled within a period of 24 hours.

When compared to the assembly time for the conventional onshore pipeline assembly process discussed above, the disclosed system 100 allows for a decrease in assembly time of at least a 20-30%. Unlike the conventional pipeline installation methods, workers do not have to setup, breakdown, and relocate their equipment along the length of the pipeline. In addition, as discussed below, once pipeline 104 has been fully assembled, it is not necessary for the pipeline to be repositioned into a trench, as the pipeline 104 may be pulled into the trench as the pipeline 104 is being assembled. This approach increases installation efficiency, as time-consuming steps associated with the “stringing” phase and “lower in” phase of the conventional pipeline installation process may be avoided. The disclosed process also minimizes the environmental impact of the pipeline installation process, as it substantially reduces the impact on the right of way for welding, lifting, and other equipment is not needed in many locations outside of the trench. In addition, a continuous building may be set up at the location of each assembly site, where each assembly station can be fully enclosed, providing a controlled environment within the building. This is in contrast with conventional methods of onshore pipeline installation, which at best only provide for minimal protection from the elements using partial enclosures, such as tents or umbrellas. Accordingly, the disclosed system and method helps prevent welding and other assembly operations from being exposed to dirt, water, and other elements. This creates a cleaner work environment that minimizes contamination, and also allows for continuous 24-hour work operations, with work being performed in a controlled climate.

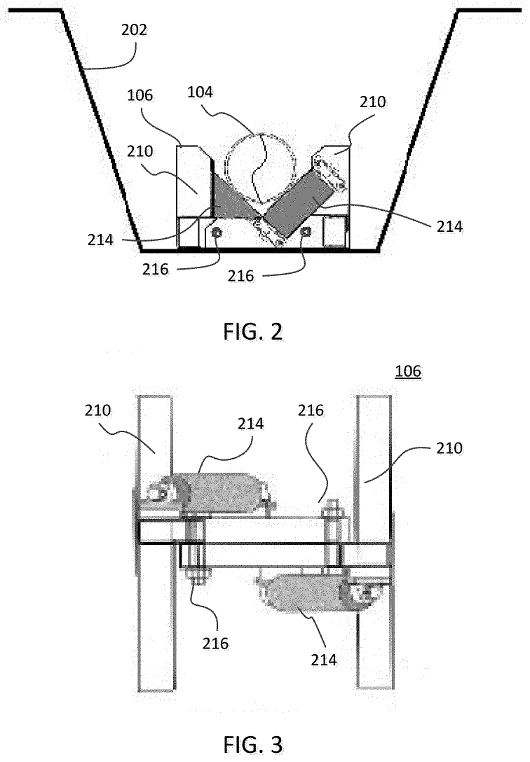

In accordance with aspects of the disclosed system and methods, winch 130 may be placed at a predetermined location so that it may pull the assembled pipeline 104 along a desired pipeline route. This route may be defined by an excavated trench that has been dug into the ground along the length of the desired pipeline route. For example, FIG. 2 provides a cross-sectional view of an assembled portion of pipeline 104 that is being pulled by a winch (not shown) within a trench 202 in a direction that is perpendicular to the cross-sectional view. Although the design and configuration of roller unit 106 may vary, FIG. 2 provides for a roller unit 106 that includes two rollers 214, with each roller connected to a roller base 210. The two roller bases 210 may be connected together by bolts, pins 216 or other means. The connection between the two roller bases 210 using pins 216 can be seen in FIG. 3, which provides a top view of roller unit 106.

Trench 202 may extend from the location of the assembly site 140 to the location of winch 130, discussed in connection with FIG. 1. As described above, the distance between assembly site 140 and winch 130 may be 5,000 to 10,000 feet or more. Given the weight of the pipeline 104 that would span this distance, the amount of force and work needed would be greater than a standard winch could provide. However, in accordance with aspects of the disclosed system and methods, FIG. 2 shows that a plurality of roller units 106 may be placed along trench 202. In particular, roller units 106 may be placed along trench 202 in a manner so as to minimize or reduce the friction associated with pulling pipeline 104 through trench 202.

The distance between any pair of roller units 106 may depend on pipeline features and terrain. For example, roller units 106 may be placed at a distance that would allow for maximum spacing between each roller unit 106, while reducing or eliminating contact between pipeline 104 and the ground while pipeline 104 is being pulled through trench 102. The flexibility of pipeline 104 will depend on the diameter and material of the pipe. Accordingly, a more flexible pipeline may require roller units 106 to be located closer together than a less flexible pipeline. Factors such as uneven terrain, changes in elevation, and turns within trench 202 may also affect the proximity that is needed between particular roller units 106.

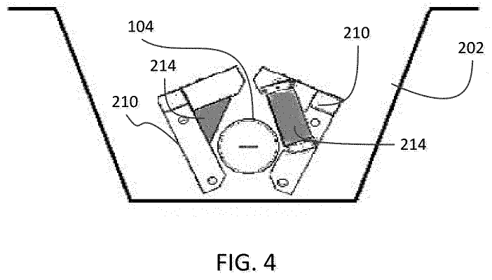

Once a portion of pipeline 104 has been pulled to the proper location within trench 202, the plurality of roller units 106 may be removed from trench 202. Roller units 106 may be designed for fast and efficient removal from trench 202. For example, FIG. 4 provides a cross-sectional view of pipeline 104 as roller unit 106 is being lifted from trench 202. In removing roller unit 106, pins 216 that are shown in FIGS. 2 and 3 are removed so as to disconnect the two roller bases 210 from each other. Each roller base 210 is then lifted out from underneath pipeline 104 on either side of pipeline 104. Once roller units 106 have been removed, trench 202 may be filed, so as to bury pipeline 104.

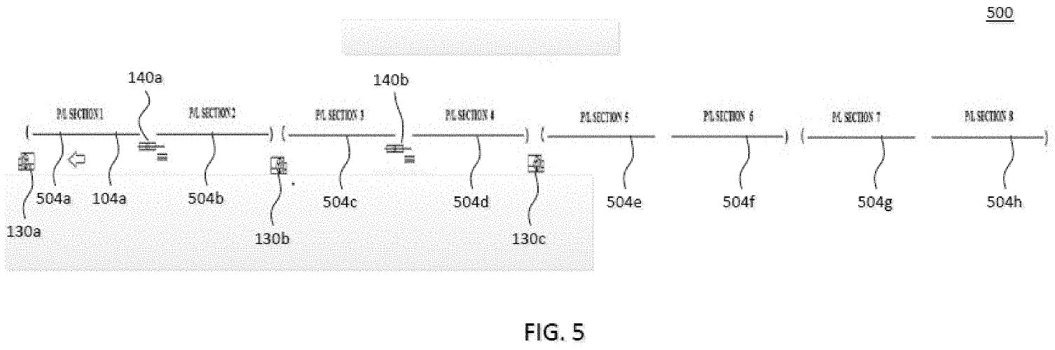

In accordance with aspects of the disclosed system and methods, the assembly and installation of pipeline 104 may be performed a plurality of times so as to create a continuous pipeline 104 that extends over any number of miles. FIGS. 5 through 12 set forth an embodiment of a pipeline installation system 500 in which three winches and two assembly sites are used to assemble and install a pipeline of many miles in an efficient manner. FIG. 5 is a diagram of a pipeline assembly system 500 in which a pipeline route has been divided into eight pipeline sections. Three winches 130a-c and two assembly sites 140a and 140b are positioned along the pipeline route between various pipeline sections so as to allow for the assembly and installation of pipeline along each section. In preparation for the installation of pipeline along each pipeline section, a trench 202 may be excavated along the pipeline route for each section and a plurality of roller units 106 may be placed within portions of trench 202 in the manner shown in FIG. 2. One or more winches 130 and assembly sites 140 may then be used to assemble and install pipeline within the trench for the pipeline sections.

In order to increase the efficiency of the pipeline installation process, it is often desirable to make each pipeline section as long as possible. The use of roller units 106 along the length of the pipeline route allows a winch 130 to be able to move thousands of feet of pipeline into place, while the pipeline is being assembled at an assembly site 140. Accordingly, each pipeline section shown in FIG. 5 can be on the order of 5,000 to 10,000 feet. In addition, multiple winches and assembly sites can be used to allow welders to move immediately from one section of pipeline to another without waiting for equipment to be transported and set up. While FIGS. 5-12 provide an example in which three winches and two assembly sites are used, the number of winches and assembly sites may vary depending on the availability of equipment and the number of workers that are available. In addition, while each pipeline route 504 is shown as being a straight path, it should be appreciated that the pipeline routes 504 can curve and have changes in elevation, depending on the terrain over which the pipeline is being installed.

As shown in FIG. 5, winch 130a has been set up at the end of section 1 that runs along pipeline route 504a. At the other end of pipeline route 504a assembly site 140a has been set up. Pipeline route 504b (section 2) extends from the location of assembly site 140a to a second winch 130b that may be set up prior to pipeline installation, and pipeline route 504c (section 3) extends from winch 130b to assembly site 140b. Pipeline route 504d (section 4) runs between assembly site 140b and winch 130c.

The pipeline installation process for pipeline sections 1 through 8 of FIG. 5 may be divided over several time periods. Time periods may be on the order of a day, however each time period may vary, depending on the length of each pipeline section, the type of pipeline that is being installed, the terrain of the pipeline route, as well as other factors. During the first time period winch, shown in FIG. 5, winch 130a pulls pipeline 104a into a trench along route 504a, while assembly site 140a assembles pipeline 104a. As set forth above, the assembly process may include welding, inspection, and coating operations. Assembly site 140b may be set up while assembly site 140a is assembling pipeline 104a of section 1, so that once pipeline 104a and 104b has been completely assembled, welders may immediately relocate to assembly site 140b and begin assembling another section of pipeline. By the end of the first time period, pipeline 104a is fully assembled and located within the trench along route 504a.

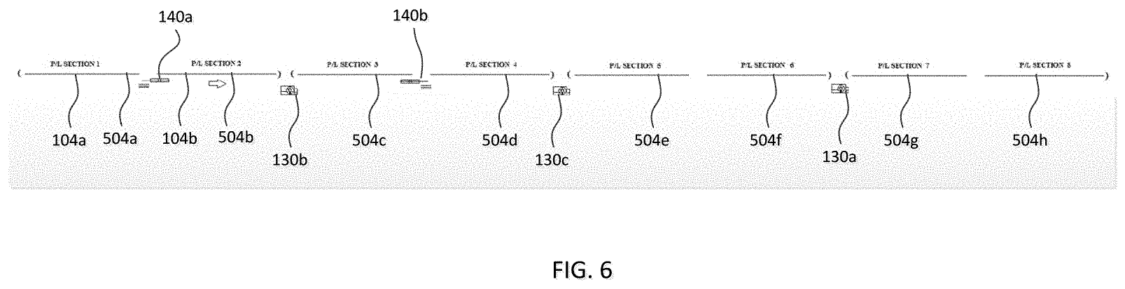

FIG. 6 is a diagram corresponding to a second time period in which winch 130b pulls pipeline 104b into a trench along route 504b, while assembly site 140a assembles pipeline 104b in the manner discussed above for pipeline 104a. In order to assembly pipeline 104b, assembly site 140a is set up to assemble in the opposite direction. In addition, a plurality of roller units (not shown) may be removed from the trench along pipeline route 504a. At this time, testing such as through the use of a Holiday Detector, may be used to verify coating integrity of pipeline 104a. If a section of pipeline passes all inspection tests, the trench for that section of pipeline may be backfilled, thereby covering that section of pipeline. While pipeline 104b of section 2 is being completed, winch 130a may be relocated between section 6 and section 7 of the pipeline route.

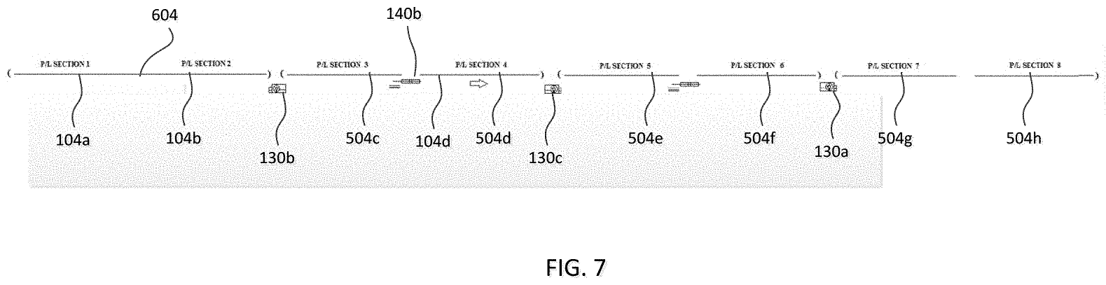

FIG. 7 is a diagram corresponding to a third time period in which winch 130c pulls pipeline 104d into a trench along route 504d where roller units (not show) have been installed. As pipeline 104d is being pulled into the trench of route 504d, assembly site 140b assembles pipeline 104d in the manner discussed above. In addition, the plurality of roller units (not shown) may be removed from the trench along pipeline route 504b. At this time, a remote weld may be performed at location 604, between sections 1 and 2, so as to connect pipelines 104a and 104b. Testing may also occur to verify coating integrity of pipeline 104b and the remote weld. While pipeline 104d of section 4 is being completed, winch 130b may be turned so that it is positioned to pull pipeline that will be installed along pipeline route 504c.

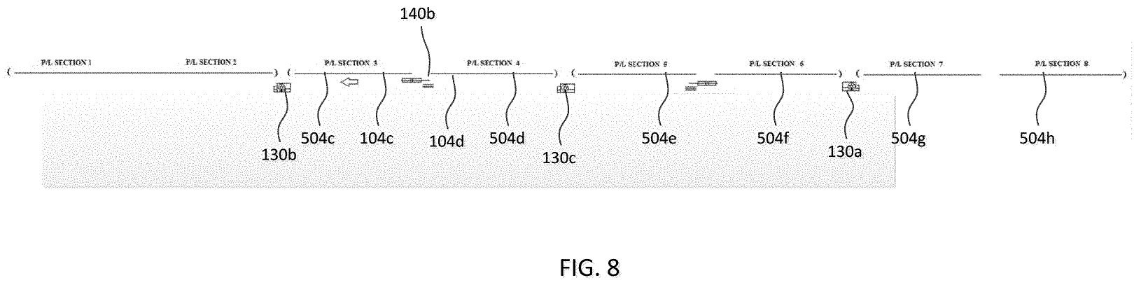

FIG. 8 is a diagram corresponding to a fourth time period in which winch 130b pulls pipeline 104c into a trench along route 504c where roller units (not show) have been installed. As pipeline 104c is being pulled into the trench of route 504c, assembly site 140b assembles pipeline 104c in the manner discussed above. In addition, a plurality of roller units (not shown) may be removed from the trench along pipeline route 504d. Testing may also occur to verify coating integrity of pipeline 104d, and the trench along route 504d may be backfilled. While pipeline 104d of section 4 is being completed, winch 130c may be turned so that it is positioned to pull pipeline that will be installed along pipeline route 504e.

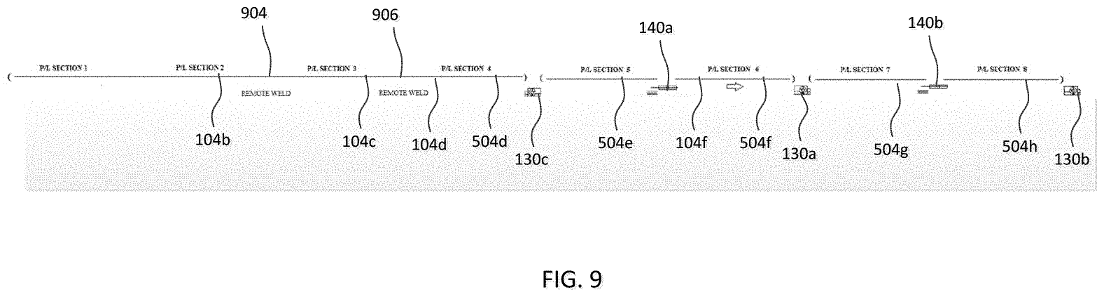

FIG. 9 is a diagram corresponding to a fifth time period in which winch 130a pulls pipeline 104f into a trench along route 504f where roller units (not show) have been installed. As pipeline 104f is being pulled into the trench of route 504f, assembly site 140a assembles pipeline 104f in the manner discussed above. In addition, a plurality of roller units (not shown) may be removed from the trench along pipeline route 504c. At this time, a remote weld may be performed at location 904, between sections 2 and 3, and at location 906, between sections 3 and 4, so as to connect pipelines 104b, 104c, and 104d. Testing may also occur to verify coating integrity of pipelines 104c and 104d, as well as the remote welds.

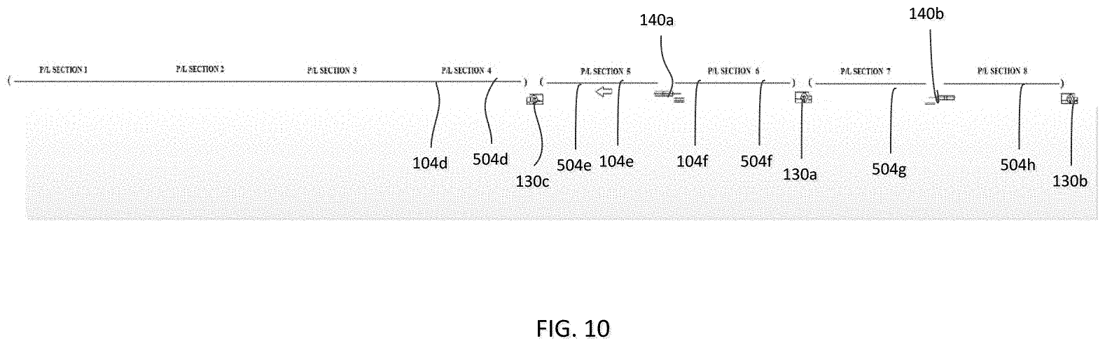

FIG. 10 is a diagram corresponding to a sixth time period in which winch 130c pulls pipeline 104e into a trench along route 504e where roller units (not shown) have been installed. Winch 130c and assembly site 140a have each been turned around so that as pipeline 104e is being pulled into the trench of route 504e, assembly site 140a is positioned to assemble pipeline 104e in the manner discussed above. In addition, a plurality of roller units (not shown) may be removed from the trench along pipeline route 504f. Testing may also occur to verify coating integrity of pipeline 104f and the trench along route 504f can be backfilled.

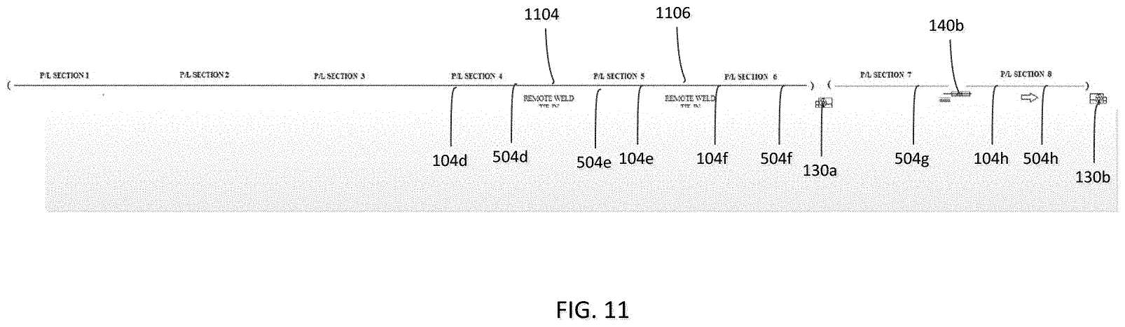

FIG. 11 is a diagram corresponding to a seventh time period in which winch 130b pulls pipeline 104h into a trench along route 504h where roller units (not shown) have been installed. As pipeline 104h is being pulled into the trench of route 504h, assembly site 140b assembles pipeline 104h in the manner discussed above. In addition, a plurality of roller units (not shown) may be removed from the trench along pipeline route 504e. At this time, a remote weld may be performed at location 1104, between sections 4 and 5, and at location 1106, between sections 5 and 6, so as to connect pipelines 104d, 104e, and 104f. Testing may also occur to verify coating integrity of these pipelines and the remote welds.

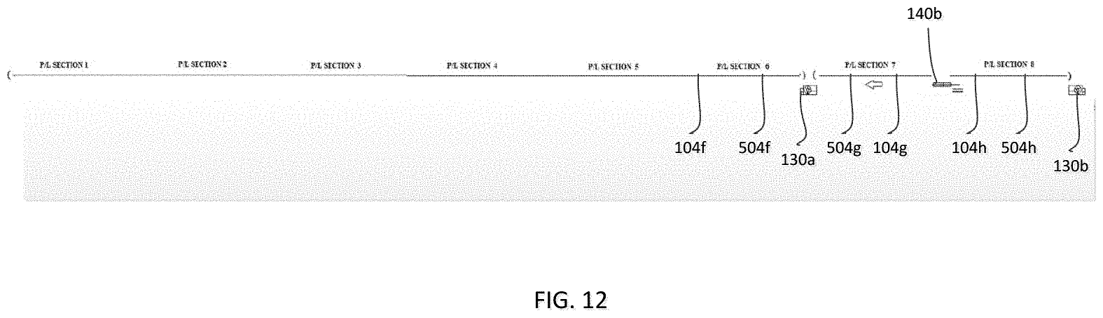

FIG. 12 is a diagram corresponding to an eighth time period in which winch 130a pulls pipeline 104g into a trench along route 504g where roller units (not shown) have been installed. As pipeline 104g is being pulled into the trench of route 504g, assembly site 140b assembles pipeline 104g in the manner discussed above. A plurality of roller units (not shown) may be removed from the trench along pipeline route 504h, and once pipeline 104g at section 7 has been completely assembled, roller units may be removed from route 504g as well. In addition, winch 130a and assembly site 140b may be relocated so as to allow for a remote weld to be performed between sections 6 and 7, as well as between section 7 and 8, so as to connect pipelines 104f, 104g, and 104h. Testing may also occur to verify coating integrity of these pipelines and the remote welds, and the trench along routes 504g and 504h may be backfilled.

The assembly and installation of pipeline sections 1 through 8 in the manner described above provides for substantial benefits over conventional methods. For example, by locating winches and assembly sites at particular locations within the trench, welders and their equipment need not perform welding along multiple locations outside of the trench along the entire length of the pipeline. Accordingly, the relocation of welding and other assembly equipment is minimized, which greatly increases worker efficiency. The environmental impact is also minimized as a right of way for welding, lifting, and other equipment is reduced along the entire pipeline. As discussed above, a continuous building may be set up within the trench at the location of each assembly site, with each assembly station be located within the building, thereby creating a clean and climate controlled work environment, and allowing for continuous 24-hour work operations.

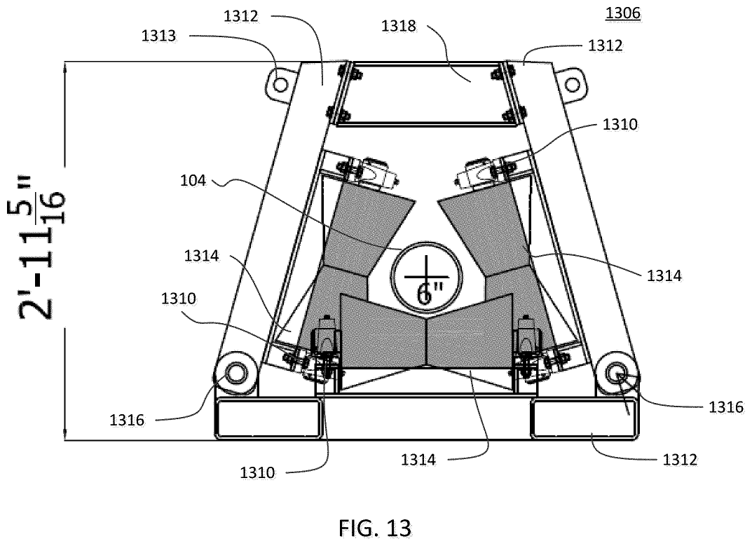

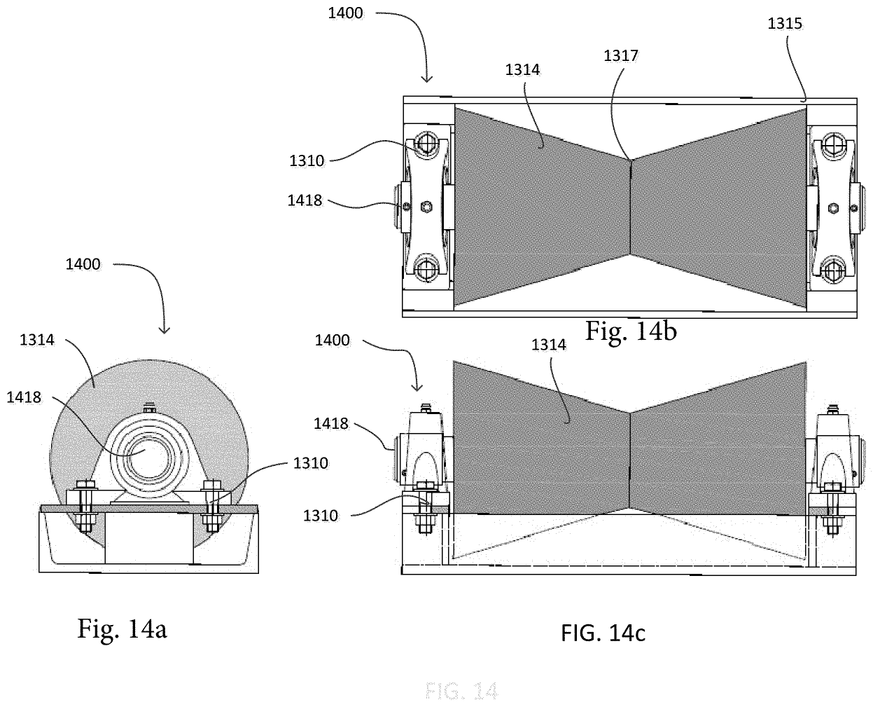

As provided above, pipeline 104 may be transported over long distances using a plurality of roller units 106. The units used to convey pipeline 104 may take any number of forms. For example, FIG. 13 is a view of a roller unit 1306 that is configured to convey a pipeline 104 that is six inches in diameter. Roller unit 1306 has a plurality of rollers 1314 that are each connected to a base 1310. The combination of a roller 1314 and its base 1310 may be referred to as a roller cartridge. FIGS. 14a-c provide three views of a roller cartridge 1400. For each roller cartridge 1400, roller 1314 may be connected to base 1310 via a rotating bearing 1418. Rotating bearing 1418 may be configured so as to allow roller 1314 to rotate freely along the axis of the roller. In accordance with one embodiment, roller 1314 may have a varied diameter. For example, a roller 1314 may have a length of sixteen inches, with the outer edges 1315 of roller 1314 having a nine inch diameter and the center 1317 of roller 1314 having a four inch diameter. This “hourglass” shape roller 1314 allows for roller cartridge 1400 to be used for pipelines 104 of different diameter.

Returning to FIG. 13, each roller base 1310 may be connected to a frame 1312. Frames 1312 may be connected together by pivot pins 1316 that allow the frames to rotate relative to one another about pivot pin 1316. For example, the frames 1312 of FIG. 13 are connected by pivot pins 1316 and positioned so that rollers 1314 are in proximity to pipeline 104. At the top of roller unit 1306, two frames 1312 are each connected to a tie-bar 1318, so as to hold the frames 1312 in place. In accordance with an aspect of the invention, each base 1310 may be connected to a frame 1312 in a manner that allows for easy replacement. In addition, each frame 1312 may contain a padeye 1313 by which the frame can be lifted or otherwise moved.

Roller unit 1306 may be used at particular locations within a trench. For example, roller unit 1306 may be positioned at or near portions of a trench that cause pipeline 104 to curve. In accordance with aspects of the invention, roller unit 1306 and the plurality of rollers 1314 within the unit may be oriented so as to assist in allowing pipeline 104 to transition around a curve. A plurality of roller units 1306 may therefore be placed within a curved portion of the trench, as well as before and after the curved portion of the trench.

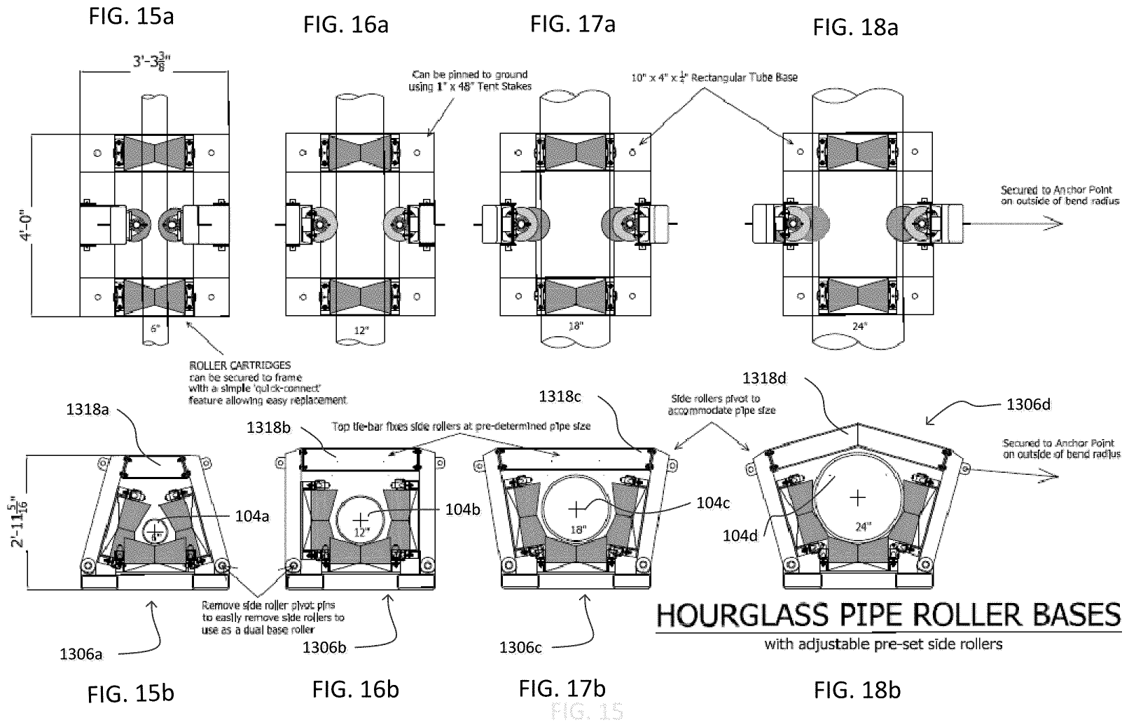

In accordance with aspects of the disclosure, roller unit 1306 may be easily adjusted to accommodate pipelines 104 of any number of diameters, as shown in FIGS. 15a through 18b. For example, FIGS. 15a and 15b provide a top and a side view of roller units 1306a-b that have been adjusted to be used with pipelines 104a-d of six-twenty four inches in diameter, respectively. As shown in FIGS. 15b, 16b, 17b, and 18b, roller units 1306a-d may use different tie-bars 1318a-d in connection with particular pipeline diameters, so that the rollers of each roller unit 1306a-d are properly positioned proximate to the pipeline 104 of each diameter. In this way, the pipeline may be stabilized as they are pulled along the pipeline route by a winch.

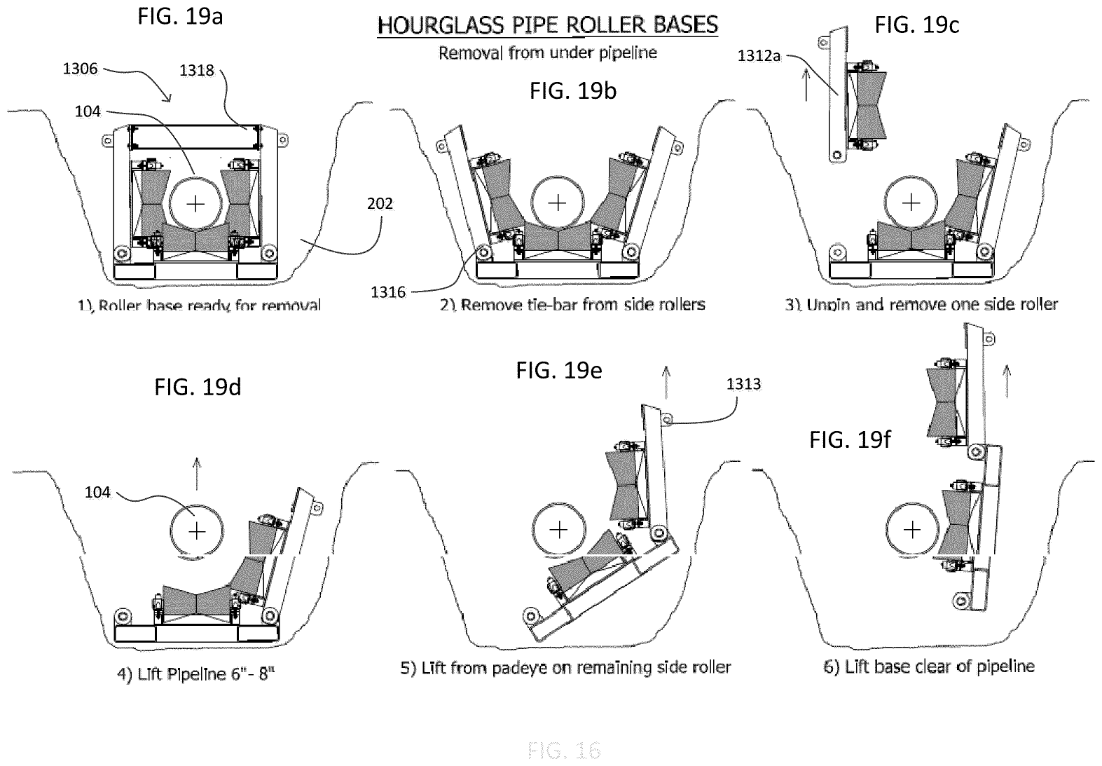

FIGS. 19a-19f provides a view of a sequence whereby a roller unit 1306 is removed from a trench 202. Once pipeline 104 has been pulled into place by the winch (not shown), roller unit 1306 may be removed from trench 202. In removing roller unit 1306, tie-bar 1318 may be disconnected from the rest of roller unit 1306 and removed, and pivot pin 1316 may be unpinned, so that frame 1312a, and its roller cartridge, may be removed from trench 202. Pipeline 104 may be lifted slightly, such as by six to eight inches, so as to allow the remained of roller unit 1306 to be removed. For example, the remainder of roller unit 1306 may be lifted by padeye 1313 so that it clears pipeline 104 and is taken out of trench 202.

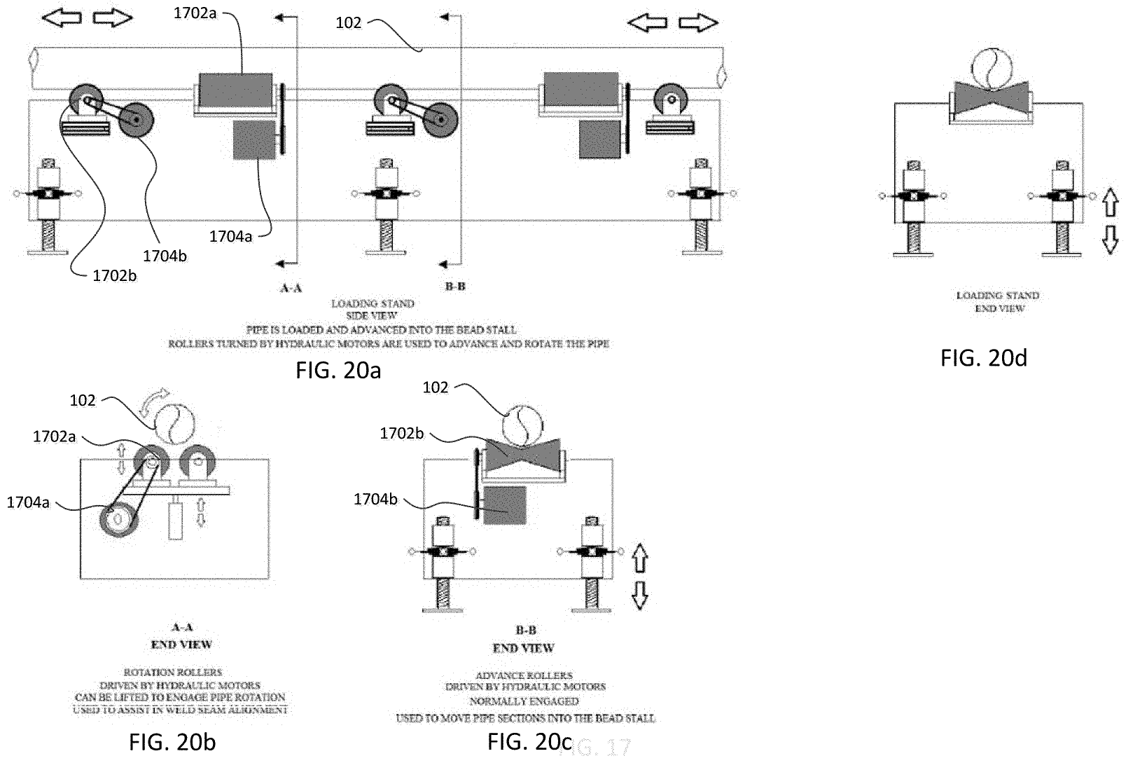

In another embodiment, one or more rollers may be driven, so as to assist in moving pipe segments 102. For example, FIGS. 20a-d provide several views of rollers 1702 that are each driven by a hydraulic motor 1704. Rollers 1702a may be configured to be driven by a hydraulic motor 1704a so as to rotate pipe segment 102, while roller 1702b may be driven by hydraulic motor 1704b and configured to assist in moving pipe segment 102 in either direction along the length pipe segment 102. Rollers 1702 may be used at an assembly site to assist in loading and positioning pipe segment 102. For example, the loading stand of FIG. 17 may be used as a prep stand 111 shown in FIG. 1, so as to assist in bringing a pipe segment 102 to assembly station 112.

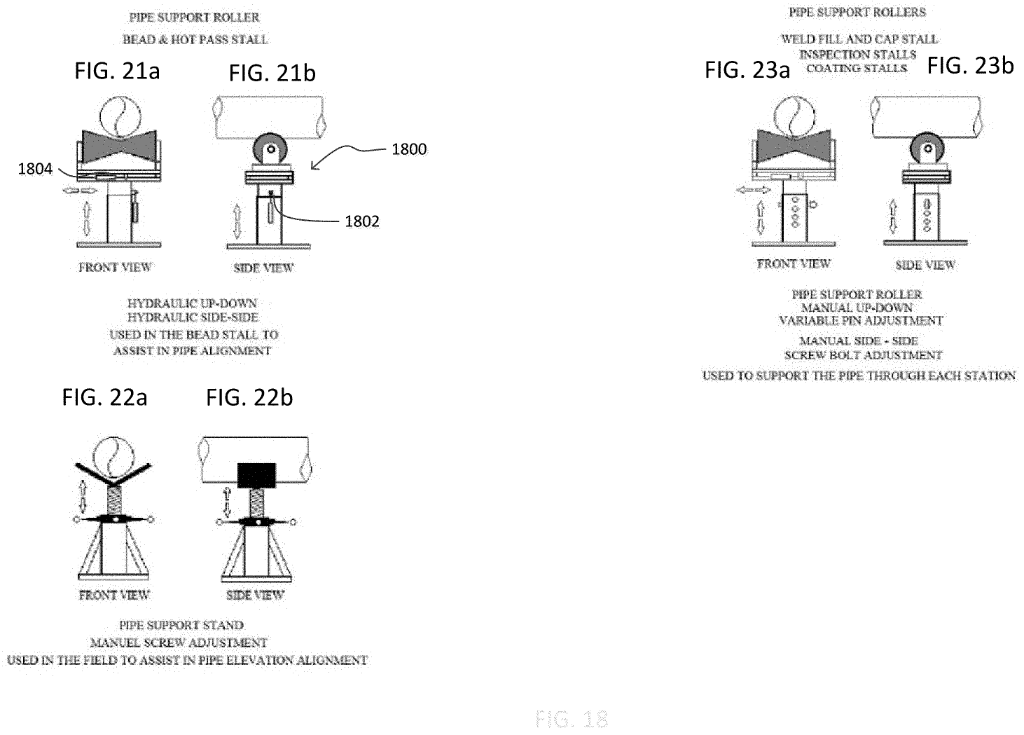

In still another embodiment, an assembly site may include a plurality of adjustable pipe support stands to position pipe segments within the assembly site. For example, several pipe support stands that can be used in one or more assembly stations within an assembly site are shown in FIGS. 21a-23b. In accordance with aspects of the embodiment, a pipe support stand 1800 may include a hydraulic lift 1802 that is configured to adjust a pipe segment in a vertical direction, as well as a hydraulic slide 1804 that is configured to move the pipe in a horizontal direction. Alternatively, pipe support stand 1800 may include a manual adjustment mechanism, such as an adjustable pin position or an adjustable screw, so as to alter the position of a pipe segment that is located on the pipe support stand 1800. In addition, a pipe support stand 1800 may include a roller, so as to allow a pipe segment to roll over the pipe support stand. One or more pipe support stands 1800 may be used in an assembly station, such as assembly station 112 of FIG. 1, in order to position and adjust the pipe segment as various assembly operations are being performed.

Although the disclosure herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A system for onshore pipeline installation comprising:
an assembly site having a plurality of assembly stations, each configured to perform one or more pipeline assembly operations;
a plurality of conveyance units located along a pipeline route, wherein at least one or more conveyance units are located within an excavated portion of the pipeline route; and
a transport unit at a second location, wherein the transport unit is configured to move the pipeline in conjunction with at least one of the plurality of conveyance units along the pipeline route a predetermined distance after completion of the pipeline assembly operations performed by the plurality of assembly stations.
